(19) United States
(12) Patent Application Publication
(10) Pub. No.: US 2020/0386408 A1
(43) Pub. Date: Dec. 10, 2020

(54) AIRCRAFT ENGINE AND METHOD OF OPERATION THEREOF

(71) Applicant: PRATT & WHITNEY CANADA CORP., Longueuil (CA)

(72) Inventors: David MENHEERE, Norval (CA); Santo CHIAPPETTA, Georgetown (CA); Timothy REDFORD, Campbellville (CA); Daniel VAN DEN ENDE, Mississauga (CA)

(21) Appl. No.: 16/719,364

(22) Filed: Dec. 18, 2019

Related U.S. Application Data
(63) Continuation of application No. 16/433,664, filed on Jun. 6, 2019.

(51) Int. Cl. F23R 3/42; F02C 3/04; F02C 7/36

(52) U.S. Cl. CPC F23R 3/42; F02C 3/04; F05D 2220/323; F05D 2220/36; F02C 7/36

(57) ABSTRACT

The aircraft engine can have a core gas path extending sequentially across a core compressor, a core combustor, and a core turbine; a boost gas path extending from an intake to the core compressor, across a boost compressor, a bypass gas path extending from the intake to the core compressor, and a bypass valve operable to selectively open and close the bypass gas path. The intake flow can be directed either across the boost gas path for increased power output, or be directed to bypass the boost gas path via the bypass gas path.

### CROSS-REFERENCE TO RELATED APPLICATIONS

This application claims priority of U.S. application Ser. No. 16/433,664 filed Jun. 6, 2019, the entire contents of which are incorporated by reference herein.

### TECHNICAL FIELD

The application related generally to gas turbine engines and, more particularly, to gas path configurations thereof.

### BACKGROUND OF THE ART

Turbine engines operate at a variety of design points, including takeoff and cruise, and are also designed in a manner to handle off-design conditions. Some aircraft can have large power differences between operating points, such as between takeoff and cruise for instance, which can pose a challenge when attempting to design an engine which is fuel efficient. Indeed, some aircraft engines are over-designed when viewed from the cruise standpoint, to be capable of handling takeoff power, which can result in operating the engine during cruise in a less than optimal regime from the standpoint of efficiency. It could be easier, based on the power requirements, to use two smaller engines at takeoff power and revert to a single powered engine in cruise. However, such a second engine may add weight, complexity, can reduce the reliability of the overall package, and can introduce subsequent challenges such as cold engine start times and one engine inoperative (OEI) requirements, if one engine is turned off in cruise flight. Accordingly, there remained room for improvement.

### SUMMARY

In one aspect, there is provided a gas turbine engine having a core gas path extending sequentially across a core compressor, a core combustor, and a core turbine, the core turbine driving the rotation of the core compressor, a boost gas path extending from an intake to the core compressor, across a boost compressor, a bypass gas path extending from the intake to the core compressor, and a bypass valve operable to selectively open and close the bypass gas path. The gas turbine engine can be an aircraft engine for instance.

In another aspect, there is provided a method of operating an aircraft engine comprising operating an engine core of the aircraft engine at a takeoff power level, including conveying air to the engine core from the atmosphere along a boost gas path and across a boost compressor; and operating the engine core of the aircraft engine at a cruise power level, including conveying air to the engine core directly from the atmosphere along a bypass gas path.

### DESCRIPTION OF THE DRAWINGS

Reference is now made to the accompanying figures in which:

FIG. 1 is a schematic cross-sectional view of a gas turbine engine;

FIGS. 2A and 2B are schematic cross-sectional views of a gas turbine showing a boost mode of operation and a bypass mode of operation, respectively; and

FIG. 3 is a schematic cross-sectional view of a turboprop gas turbine engine.

### DETAILED DESCRIPTION

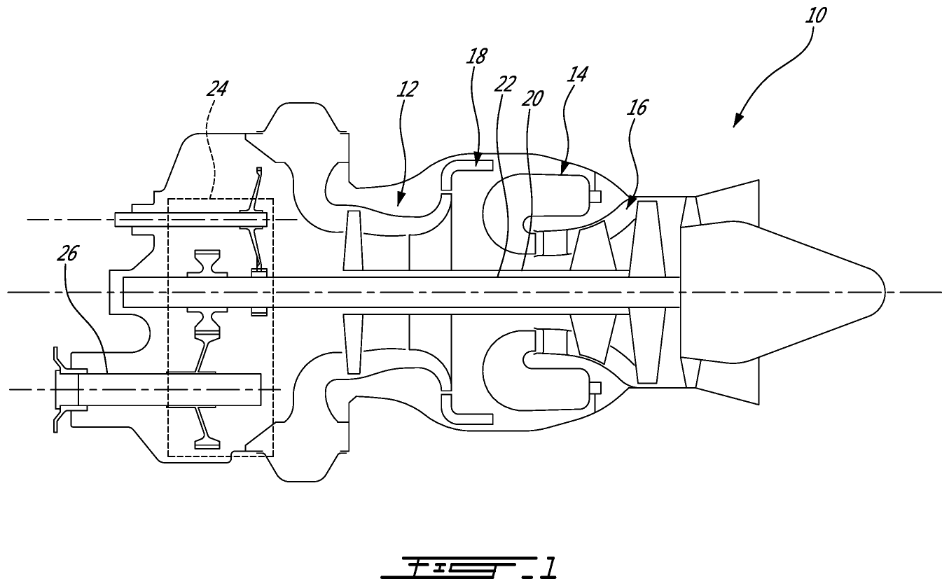

FIG. 1 illustrates an example of a turbine engine. In this example, the turbine engine 10 is a turboshaft engine generally comprising in serial flow communication; a multistage compressor 12 for pressurizing the air, a combustor 14 in which the compressed air is mixed with fuel and ignited for generating an annular stream of hot combustion gases, and a turbine section 16 for extracting energy from the combustion gases. The turbine engine terminates in an exhaust section.

The fluid path extending sequentially across the compressor 12, the combustor 14 and the turbine 16 can be referred to as the core gas path 18. In practice, the combustor 14 can include a plurality of identical, circumferentially interspaced, combustor units. In the embodiment shown in FIG. 1, the turboshaft engine 10 has two compressor and turbine stages, including a high pressure stage associated to a high pressure shaft 20, and a low pressure stage associated to a low pressure shaft 22. The low pressure shaft 22 is used as a power source during use, and the low pressure turbine can thus be referred to as a power turbine.

Turboshaft engines, similarly to turboprop engines, typically have some form of gearing by which the power of the low pressure shaft 22 is transferred to a load. The load can be an external shaft 26 bearing the blades or propeller, or an electric generator for instance. Some turbofan designs can also have some form of gearing via which power is transferred to a shaft bearing a fan, such as an aft fan arrangement for instance. Gearing, which can be referred to as a gearbox 24 for the sake of simplicity, typically reduces the rotation speed to reach an external rotation speed which is better adapted to a rotation speed of the load.

Some applications, such as helicopters to name one example, can have large power differences between Take-Off (TO) and cruise. In some embodiments, a further power requirement can exist, such as a 30 second one-engine inoperable (OEI) power requirement for instance, which can be even higher than the Take-off power requirement. A typical helicopter can require less than 50% power to cruise versus its highest power rating. Since an engine can be significantly more fuel efficient at its design power, designing the engine to the take-off power level, or to the OEI power level, for instance, can result in the engine running in off-design condition for the majority of its mission, leaving a want for better fuel efficiency.

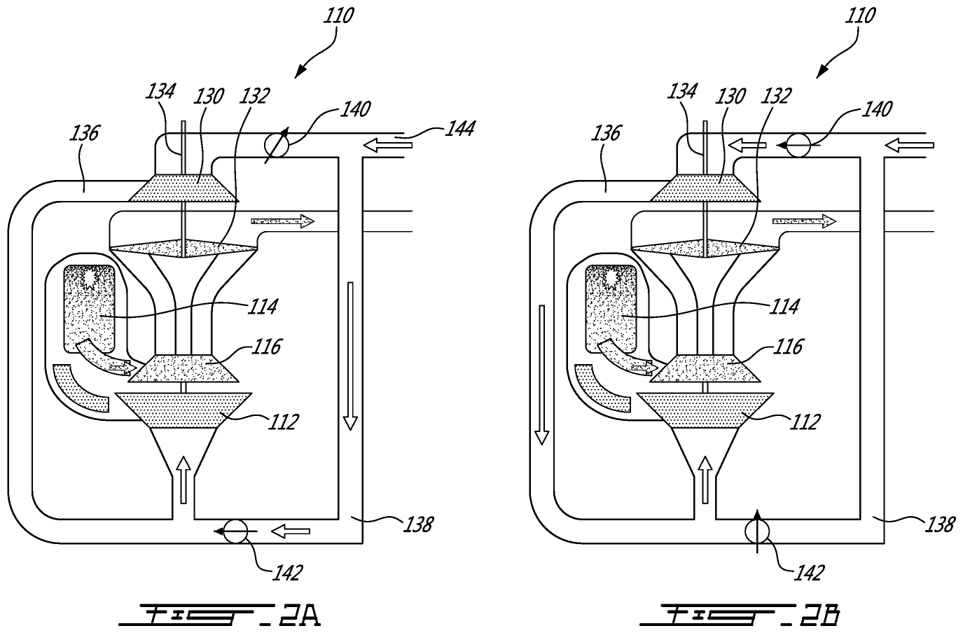

FIGS. 2A and 2B show an example of an aircraft engine 110 which has an engine core having a core compressor 112, a core combustor 114, and a core turbine 116, and further has a selectively useable boost compressor 130. More specifically, FIG. 2B shows the engine during operation of the boost compressor 130, during which the engine can efficiently produce a higher power level, such as takeoff power for instance, whereas FIG. 2A shows the engine operating in a manner to bypass the boost compressor 130, during which the engine can efficiently produce a lower power level, such as a cruise power level for instance. More specifically, the boost compressor 130 can be provided in a boost gas path, and be selectively operated to increase the pressure upstream of the core compressor 112, leading to higher pressure operation of the engine core, and to a greater power output.

A power turbine 132 can be used in addition to the core turbine 116. The power turbine 132 can be between the core turbine 116 and the exhaust, for instance. The power turbine 132 can be connected to a load via a power shaft 134, and optionally via a gearbox for instance. In this embodiment, the core turbine 116 is drivingly connected to the core compressor 112 via a core shaft. The power shaft 134 can be distinct from the core shaft, and even be deposed from it, and used to further drive the core compressor, for instance.

When operating the aircraft engine at a cruise power, such as shown in FIG. 2B, the boost compressor 130 can be entirely bypassed. In the illustrated embodiment, this can be achieved via selectively closing the boost gas path 136 while allowing intake flow through the bypass gas path 138. This can be achieved by various devices or systems which will be referred to herein generally as a “valves” for the sake of simplicity. The valve positioned upstream of the boost compressor in the boost gas path can be referred to specifically as the boost valve 140, or as a throttle valve in one embodiment, whereas the valve positioned in the bypass gas path can be referred to specifically as the bypass valve 142, and can be a check valve, for instance.

At takeoff, for instance, the boost gas path 136 can be used by operating the boost valve 140 accordingly. In this mode of operation; air can be drawn in from the atmosphere (here more specifically via a common intake 144), preferentially via the boost gas path due to the aspiring action of the boost compressor. The boost compressor will increase pressure relative to ambient atmospheric pressure, and a simple check valve in the bypass gas path 138 can be sufficient to avoid flow reversal in the bypass gas path 138. The pressure immediately upstream of the core compressor 112 will be higher than in the bypass mode due to the action of the boost compressor 130 and bypass valve 142, leading ultimately to a higher power output of the power turbine 132. This power output can correspond to a takeoff power level.

When switching to a cruise mode, the power output can be reduced from the takeoff power level until ultimately the boost compressor is deemed not required. At this point, the boost valve 140 can be operated to close the boost gas path 136 and the bypass valve 142 can allow air through the bypass gas path 138. The core compressor 112 will perform an aspiring action lowering the pressure upstream of the core compressor 112, typically to below ambient atmospheric pressure. In this embodiment, the boost valve 140 can conveniently be positioned upstream of the boost compressor 130 in the boost gas path 136, to allow the boost compressor 130 to idle in this low pressure environment, and thus limit aerodynamic losses caused by this idling by contrast with idling in a higher pressure environment.

It will be noted that the selective operation, or closing, of the boost gas path 136 can be performed without negatively affecting the operation of the core gas path 118. Accordingly, during a typical flight, the same engine can be operated in two or more operating modes which can produce a significantly different power level while always operating at a relatively high level of efficiency, and without requiring an additional engine altogether. It will also be noted that the two different power levels can be achieved without a significant change of rotation speed of the turbine shaft, for instance. During the switching from one mode to another, there can be a moment when both valves 140, 142 can be simultaneously, partially open, however, it can be preferred to limit the duration of such simultaneous partial opening to avoid recirculation of compressed air outputted by the compressor 130 to the air intake 144.

In the context of a helicopter, for instance, it can be desired for the rotation speed of the power turbine's shaft not to vary too much between the different power levels. The rotation speed of the turbine at the takeoff power level can be less than 140% of the rotation speed of the power turbine at the cruise power level, for instance, possibly less than 130% (e.g. for turboprop), possibly less than 110% (e.g. for turboshaft), and even possibly less than 105%. This while the amount of power generated at the cruise power level can be less than ¾ of the amount of power generated at the takeoff power level, possibly less than ⅔^{rd}, and even possibly less than ½.

The effect of the boost pressure on the engine can have the effect of increasing the power output in direct relation to the pressure ratio. Accordingly, doubling the power output of the engine can be accomplished by doubling the boost pressure entering the core. A configuration where the power shaft is deposed and separate from the core shaft, with the boost compressor isolated, can avoid scenarios where a shaft has to extend within another shaft, which are less desired because of potential dynamic instability. In an example where the OEI power level is higher than the takeoff power level, an aircraft engine can be designed in a manner for the OEI power level to be reachable by operating the core gas path via the boost gas path at full power, for instance.

In one embodiment, an optional heat exchanger or cooler can be used in the boost gas path, downstream of the boost compressor.

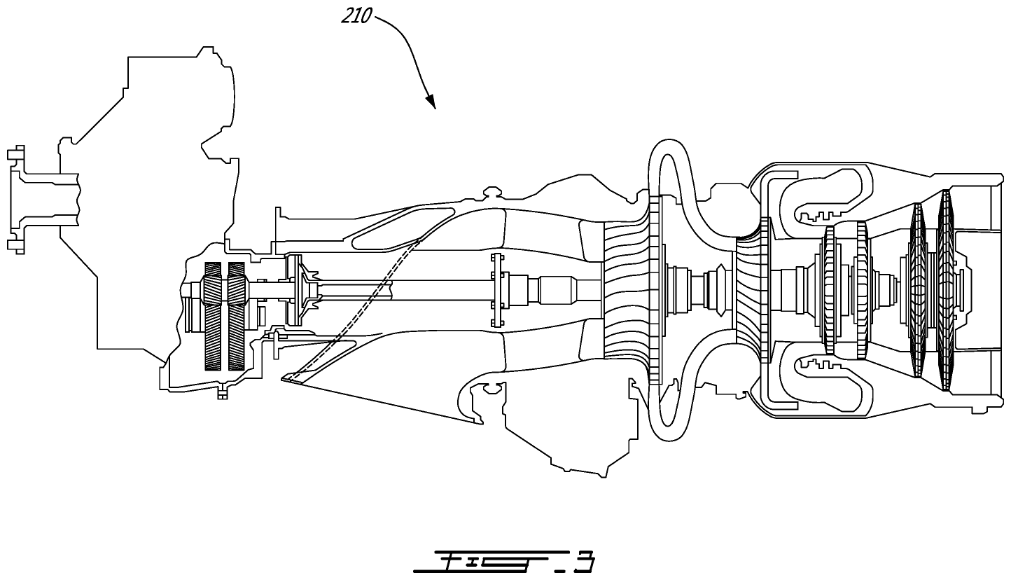

The above description is meant to be exemplary only, and one skilled in the art will recognize that changes may be made to the embodiments described without departing from the scope of the present technology disclosed. Indeed, various modifications and adaptations are possible in alternate embodiments. The bypass gas path and boost gas path can be referred to being distinct paths, and gas path portions referred to as plenums can be used in both modes of operation. In the embodiment shown, there is an intake plenum and a compressor inlet plenum, but other configurations are possible. In the embodiment presented above, the boost gas path and the bypass gas path share a common air intake. In alternate embodiments, the boost gas path and the bypass gas path can have respective, independent air intakes, and each air intake can include one or more air breathing aperture. In the embodiment shown, the power turbine is used to drive the boost compressor and the load, and is distinct from the core turbine. In alternate embodiments, the power turbine can be drivingly connected to the core turbine, or positioned between the combustor and the core turbine, and a different arrangement or core turbine and/or power turbine can be used to drive the core compressor, boost compressor and/or load. The embodiments described herein can be applied to different engine architectures. FIG. 3, for instance, illustrates a turboprop 210 adapted to drive a propeller, and which may be modified based on the teachings presented above in a manner to incorporate a selectively useable second gas path powered by a second combustor. In still another embodiment, the boost gas path and boost compressor can be used on another type of aircraft engine core, such as a rotary (e.g. Wankel) engine core for instance. Still other modifications which fall within the scope of the present technology will be apparent to those skilled in the art, in light of a review of this disclosure.

1. A gas turbine engine having:
a core gas path extending sequentially across a core compressor, a core combustor, and a core turbine;
a boost gas path extending from one or more of at least one air intake to an air inlet of the core compressor;
a boost compressor in the boost gas path;
a bypass gas path extending from one or more of the at least one air intake to the core compressor; and
a bypass valve operable to selectively open and close the bypass gas path.

2. The gas turbine engine of claim 1 further comprising a power turbine downstream of core turbine in core gas path, power turbine being drivingly connected to a gearbox.

3. The gas turbine engine of claim 2 wherein the aircraft engine is a turboshaft engine, further comprising helicopter blades mounted to a power shaft, the power shaft drivingly connected to the gearbox.

4. The gas turbine engine of claim 2 wherein the aircraft engine is a turboprop engine, further comprising a propeller mounted to a power shaft, the power shaft being drivingly connected to the gearbox.

5. The gas turbine engine of claim 2 wherein the power turbine is further drivingly connected to the boost compressor, and the core turbine drives the rotation of the core compressor.

6. The gas turbine engine of claim 1 further comprising a boost valve operable to selectively open and close the boost gas path.

7. The gas turbine engine of claim 6 wherein the boost valve and the bypass valve are configured to open when the other closes, and to close when the other is opened.

8. The gas turbine engine of claim 6 configured to operate at a power level corresponding to a takeoff power requirement of the aircraft engine when intake air is conveyed through the boost gas path, and configured to operate at a power level corresponding to a cruise power requirement of the aircraft engine when intake air is conveyed through the bypass gas path.

9. A method of operating an aircraft engine comprising
operating an engine core of the aircraft engine at a takeoff power level, the operating at the takeoff power level including conveying air to the engine core from the atmosphere while increasing pressure of the air at a location upstream of the engine core with a boost compressor; and
subsequent to the operating at the takeoff power level, operating the engine core of the aircraft engine at a cruise power level, the operating at the cruise power level including conveying air to the engine core from the atmosphere while bypassing the boost compressor.

10. The method of claim 9 wherein said operating an engine core at both takeoff power level and cruise power level includes circulating air sequentially across a core compressor, a core combustor, and a core turbine.

11. The method of claim 10 further comprising driving said core compressor via said core turbine.

12. The method of claim 10 further comprising driving a power turbine using gas from the engine core, and driving a gearbox with the power turbine.

13. The method of claim 12 further comprising driving the boost compressor with the power turbine.

14. The method of claim 12 further comprising powering a load with a power output of the gearbox, said power output of the gearbox corresponding to said takeoff power level, and subsequently to said cruise power.

15. The method of claim 9 further comprising switching from the takeoff power to the cruise power, including simultaneously closing the boost gas path and allowing air flow from the atmosphere to the core compressor along the bypass gas path.

16. The method claim 9 further comprising switching from the cruise power to the takeoff power, including simultaneously opening the boost gas path and preventing flow reversal in the bypass gas path.

17. The method of 12 wherein a rotation speed of the power turbine at the takeoff power level is less than 120% of a rotation speed of the power turbine at the cruise power level.

18. The method of claim 12 wherein a rotation speed of the power turbine at the takeoff power level is less than 110% of a rotation speed of the power turbine at the cruise power level.

19. The method of claim 9 wherein the cruise power level is of less than % of the takeoff power level.

20. The method of claim 9 wherein said operating the engine core of the aircraft engine at a cruise power level includes maintaining a pressure lower than a pressure of the atmosphere in the boost gas path.
